(19) United States
(12) Patent Application Publication
(10) Pub. No.: US 2019/0058578 A1
(43) Pub. Date: Feb. 21, 2019

(54) ENCRYPTION SYSTEM INCLUDING AN ONLINE TESTER

(71) Applicant: Intel Corporation, Santa Clara, CA (US)

(72) Inventor: David Johnston, Hillsboro, OR (US)

(21) Appl. No.: 15/679,266

(22) Filed: Aug. 17, 2017

(51) Int. Cl. H04L 9/06; H04L 29/06; G06F 11/22

(52) U.S. Cl. CPC H04L 9/065; G06F 11/26; G06F 11/2294; H04L 63/0471

(57) ABSTRACT

Systems, apparatuses and methods may provide for technology that receives entropy data from an entropy source, determines a measurement of a serial correlation of values of bits of the entropy data, and determines, based upon the measurement of the serial correlation, if the entropy data is suitable as a basis for an encryption operation to be performed on data.

### TECHNICAL FIELD

Embodiments generally relate to data security. More particularly, embodiments relate to encryption systems.

### BACKGROUND

An entropy source may generate data with reference to a seemingly random action such as, for example, a time between a user's keystrokes or a mouse movement. Some entropy sources may be digital. Analysis of the entropy source output, however, may show that values of the data do not distribute evenly across the space of all possible values because some values are more likely to occur than others and certain values almost never occur in practice. If the data from the entropy source is used as a basis for an encryption operation, suboptimal performance may result.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of an encryption system according to an embodiment;

FIG. 2 is a flowchart of an example of a method of operating an online tester according to an embodiment;

FIG. 3 is an illustration of an example of an online tester according to an embodiment;

FIG. 4 is an illustration of an example of a counting subsystem according to an embodiment;

FIG. 5 is a graph of an example of a measured serial correlation coefficient to actual serial correlation coefficient;

FIG. 6 is a graph of an example of a minimum entropy to serial correlation coefficient; and

FIG. 7 is an illustration of an example of an online tester according to an embodiment;

FIG. 8 illustrates an example of a security-enhanced computing system according to an embodiment;

FIG. 9 illustrates an example of a processor core according to an embodiment; and

FIG. 10 illustrates a block diagram of a computing system according to an embodiment.

### DESCRIPTION OF EMBODIMENTS

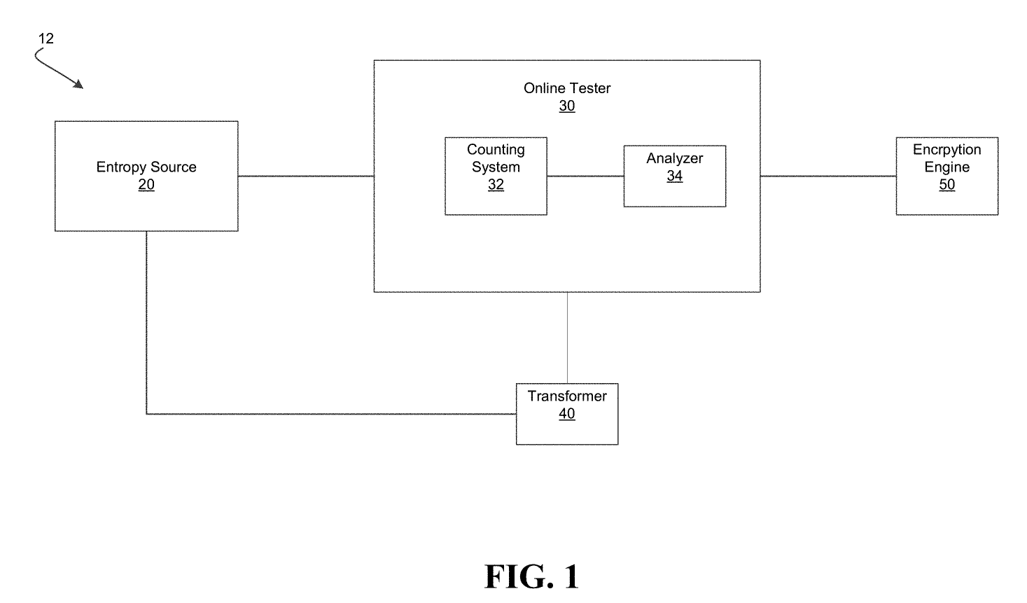

FIG. 1 illustrates an encryption system 12. The encryption system 12 may include an entropy source 20 such as a hardware entropy source that produces entropy data. The entropy source 20 may be a random number generator such as, for example, a digital random number generator. The entropy data may be binary to include “1” (high) and “0” (low) values. An online tester 30 may be connected to the entropy source 20 to receive the entropy data from the entropy source 20. The online tester 30 may perform an online health test (OHT) designed to measure the quality of entropy data generated by the entropy source 20. In one example, the online tester 30 utilizes a counting system 32 and an analyzer 34 to determine if the entropy data is sufficiently random.

For example, the online tester 30 may determine a numerical correlation, which may be a serial correlation that is a linear measure, of the entropy data. The numerical correlation may be compared against threshold value(s) to determine if the entropy data is sufficiently random. In some embodiments, the counting system 32 may measure specific values (e.g., frequency of a value, frequency of directly adjacent bits being the same, and a total number of bits) of the entropy data with the counting system 32. The specific values may be analyzed by the analyzer 34 to determine a numerical correlation by determining if the specific values correspond to a specific statistical correlation indicating that the entropy data is sufficiently random. A transformer 40 may perform various operations on the entropy data to further modify the entropy data and address potential statistical biases as well as sampling. Thus, the transformer 40 may provide transformed data based upon the entropy data.

Accordingly, the transformed data may have increased entropy per bit of data compared to the entropy per bit of the entropy data. The transformed data may be passed to an encryption engine 50, via the analyzer 34, when the analyzer 34 makes a determination whether the entropy data is sufficiently random. The encryption engine 50 may perform an encryption operation based upon the transformed data, and may include a conditioner which mixes several instances of transformed data together, where each transformed data is based upon a different entropy data produced by the entropy source 20. The encryption operation may include generating an encryption key and/or encrypting data for example.

Entropy source circuits may exhibit bias (where a bit or pattern is more likely than another) and serial correlation, where the value of a previous bit or bits influences the value of following bits. The entropy data produced by the entropy source 20 may be analyzed to determine if the entropy data is random or is nonrandom (e.g., at least one of if a bit position of the entropy data bears a relationship to a bit value, if a bit values are following a pattern such as alternating in value between low and high, if each bit value has an association with a directly previous bit value thereto, if the bit value bears a relationship to time, or if the bit value is more likely to take one value than another. Such an analysis may indicate whether the entropy source 20 is in “good health” by producing random numbers, or in “poor health” by producing nonrandom numbers. The online tester 30 may receive the entropy data directly from the entropy source 20 before the entropy data is transformed (e.g., XOR feedback, synchronization, under sampling) by the transformer 40. The entropy data may be analyzed by the online tester 30 to determine whether the data is randomized (e.g., does not follow a pattern), or is nonrandomized (e.g., follows a pattern). If the entropy data is sufficiently random and may be suitable as a basis for an encryption operation by the encryption engine 50, the transformed data, which is based upon the entropy data, may be labeled as “healthy.” The “healthy” label may be a “first label.” Once the encryption engine 50 receives a sufficient number of “healthy” transformed data, the encryption engine 50 may perform the encryption operation to encrypt data.

For example, the entropy data may be analyzed to determine a measurement of a statistical correlation, which is a serial correlation coefficient, that may be a linear measurement. If the statistical correlation is within a predetermined range, the entropy data may be deemed to be sufficiently random. If, however, the measurement of the correlation is outside of the range, the entropy data may be considered insufficiently random, and to be nonrandom. Such entropy data and corresponding transformed data is labeled “unhealthy.” The “unhealthy” label may be a “second label.” If the online tester 30 determines that the entropy data is random, the transformed data is labeled as healthy and may be suitable as a basis for a future cryptography operation. If, however, the entropy data is determined to be nonrandom and the transformed data is therefore labeled as unhealthy, the transformed data may need to be processed further, for example by being combined with other data, before being used in a cryptography operation, or may be discarded altogether.

In some embodiments, the encryption engine 50 may only perform the encryption operation if a sufficient amount of healthy transformed data has been received by the encryption engine 50. For example, the transformed data may be 256 bits long, and the encryption engine may require 1024 bits of healthy transformed data. Therefore, the encryption engine 50 may perform the encryption operation when four instances of healthy transformed data, each being 256 bits, are received. A threshold may be set and adjusted based upon an extent of the statistical correlation, and a desired level of randomness.

In contrast, a pass/fail analysis may count properties of the data to determine whether the transformed data passes or fails. Such a binary result may not allow for adjustable thresholds, and may not allow for an accurate determination as to whether the entropy source is in good health, medium health or poor health. For example, even entropy sources in poor health may occasionally be registered as passing in a pass/fail analysis. Furthermore, only two categories (e.g., pass and fail) exist for classifying the entropy source. In contrast, a linear measure (e.g., serial correlation coefficient) allows a more accurate determination of the health of an entropy source. For example, by using a measurement of a statistical correlation, the entropy source 20 may be more accurately determined as being in good health or poor health since a more accurate measurement of the “randomness” of the data produced by the entropy source 20 is determined. In detail, a numerical measurement of the entropy of the entropy data may be determined. This may evaluate a change in entropy quality as process, voltage, temperature or attacks change the behavior of the entropy source 20. For example, a range of values (e.g., from −1.0 to 1.0) may be used to describe the randomness of the entropy data when using the serial correlation coefficient. In contrast, only two values may be used in a pass/fail analysis. Therefore, a more accurate determination of the randomness of the entropy data is determined when using the serial correlation coefficient. Thus, an overall trend (e.g., degradation of the randomness of the entropy data over time) of the entropy data may be analyzed to determine if the entropy source 20 is declining, but still producing acceptable entropy data.

Furthermore, the online tester 30 may analyze the entropy data rather than the transformed data which is transformed by the transformer 40. By doing so, a more accurate determination is made as to the health of the entropy source 20. In contrast, if the online tester 30 measured the transformed data to determine randomness, a less accurate assessment as to the health of the entropy source 20 and entropy data is determined because the original entropy data is not being measured.

Moreover, the illustrated online tester 30 operates in “real-time.” For example, the entropy data may be analyzed by the online tester 30, then the transformed data is labeled as being healthy or not healthy based upon the analysis. If the transformed data is acceptable, then the transformed data may be used by the encryption engine 50.

The entropy source 20 may be an analog circuit, ring oscillator or a meta source which produces entropy data. The entropy source 20 may receive random noise from the environment and produce the entropy data based upon the random noise. The entropy data may be a binary sequence that only includes bits.

The transformer 40 may be a hardware circuit that transforms the entropy data. The entropy source 20 may operate in accordance with clock cycles. These clock cycles may be different from that of the online tester 30, and in particular that of the analyzer 34. Therefore, the transformer 40 may include at least one “exclusive or” (XOR) gate to perform feedback operations. For example, the at least one XOR gate may be used to accumulate, mix together and store entropy data which has not yet been used due to under sampling as explained below. The transformer 40 may also perform synchronization to allow for crossing over from the clock domain of the entropy source 20 to that of the analyzer 34. The clock cycles of the entropy source 20 may be faster than that of the analyzer 34. The transformer 40 may perform undersampling to only pass through some values of the entropy data, as the transformed data (e.g., 256 bits out of 1024 bits), to the analyzer 34 due to the difference in the clock domains. The transformer 40 may be able to transform the entropy data to allow the transformed data to have increased entropy, which may pass a health test, whereas the original entropy data may fail the health test. Therefore, the entropy data, rather than the transformed data, is tested and analyzed by the online tester 30.

The online tester 30 may include the counting system 32, which may be hardware, and the analyzer 34. The counting system 32 may include for example, flip-flops and hardware counters. In an embodiment, the analyzer 34 may be implemented by a register transfer language (RTL). The analyzer 34 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), complementary metal oxide semiconductor (CMOS) or transistor-transistor logic (TTL) technology, or any combination thereof. In some embodiments, the counting system 32 may also be implemented in one or more modules as a set of logic instructions stored in a machine- or computer-readable storage medium such as RAM, ROM, PROM, firmware, flash memory, etc., in configurable logic such as, for example, PLAs, FPGAs) CPLDs, in fixed-functionality logic hardware using circuit technology such as, for example, ASIC, CMOS or TTL technology, or any combination thereof.

Furthermore, various functions of the analyzer 34 may be written in any combination of one or more programming languages, including RTL, an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

The counting system 32 may count a number of times a specific value occurs in the entropy data, as well as a number of times other predefined instances of interest occur in the entropy data. Furthermore, the counting system 32 may count how many total bits have been passed to the counting system 32 since a last reset operation.

The analyzer 34 may receive the counts from the counting system 32, and perform a statistical analysis of the entropy data. For example, the analyzer 34 may determine the serial correlation coefficient (SCC) based upon the counts, as well as determine the mean value of the entropy data. The SCC may be a measure of the relationship between successive values (e.g., high or low) ordered in time, space or bit position. For example, the SCC may be the measurement of the extent to which a value of a bit (e.g., xᵢ₊₁) in the entropy data depends upon a value of a directly previous bit (e.g., xᵢ) of the entropy data. The SCC may correspond to a linear association between values of the entropy data and bit positions, or an association between each bit value and a previous bit value (e.g., alternating values).

From the SCC and the mean, the analyzer 34 may determine whether the entropy data is sufficiently random. For example, if the SCC is within predefined boundaries, and if the mean is within predefined boundaries, the entropy data may be sufficiently random. If the entropy data is sufficiently random, the analyzer 34 may label the transformed data as healthy, and provide the transformed data to the encryption engine 50. If, however the entropy data is not sufficiently random, the analyzer 34 may not pass the transformed data to the encryption engine 50, or label the transformed data as unhealthy and pass along the unhealthy transformed data to the encryption engine 50 for further processing.

The encryption engine 50 may perform the encryption operation. The encryption operation may include converting unencrypted data into a code to prevent unauthorized access. The encryption operation may include using the transformed data to transform the unencrypted data into the code. As noted above, the encryption engine 50 may only receive the transformed data if the analyzer 34 determines that the entropy data is suitable, or receive unhealthy transformed data and await other health transformed data to be received before performing the encryption operation.

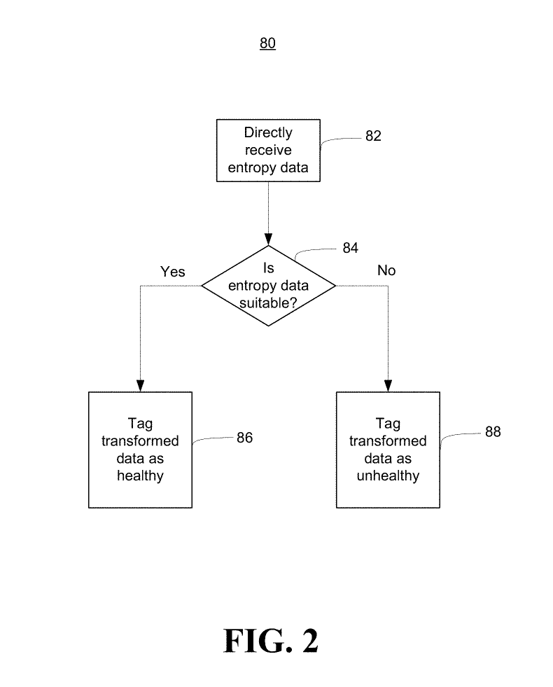

FIG. 2 shows a method 80 of operating an encryption system. The method 80 may generally be implemented in an encryption system such as, for example, the encryption system 12 (FIG. 1), already discussed. More particularly, the method 80 may be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, CMOS or TTL technology, or any combination thereof.

For example, computer program code to carry out operations shown in the method 80 may be written in any combination of one or more programming languages, including an object oriented programming language such as RTL, JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 82 may, at an online tester, directly receive entropy data from an entropy source. The entropy data, which is received directly by the online tester, may not be transformed in any way after being produced by the entropy source. In processing block 84, the online tester may determine if the entropy data is a suitable basis for an encryption operation. If so, in block 86 transformed data, which is the entropy data that is transformed, is labeled as healthy. If in block 84 the entropy data is not suitable as the basis for an encryption operation, the transformed data is labeled as unhealthy in block 88. While not illustrated, unhealthy transformed data may be discarded, or passed to an encryption engine. While not illustrated, healthy transformed data may be passed to the encryption engine.

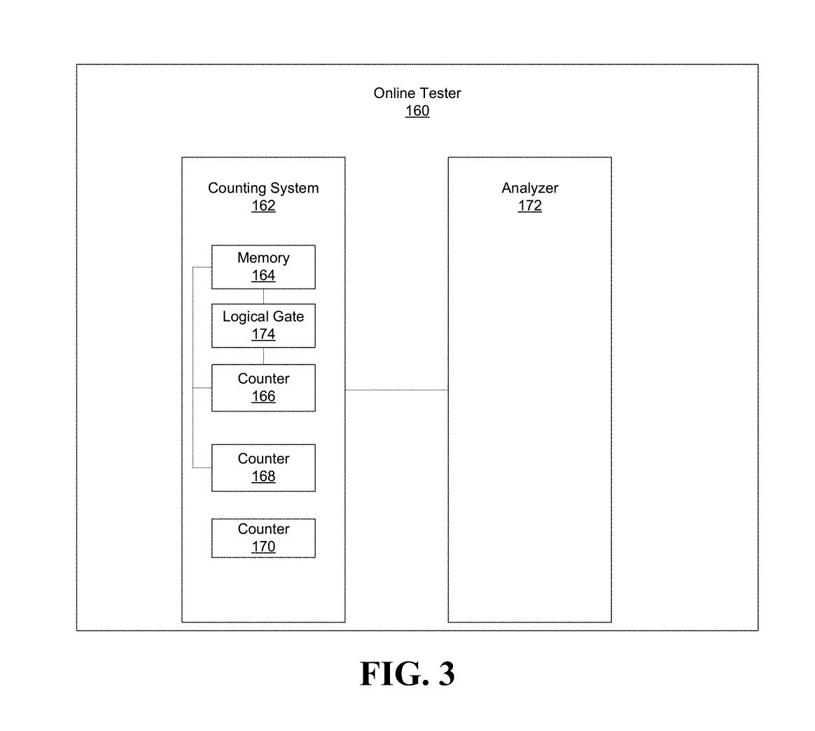

FIG. 3 illustrates an online tester 160. The online tester 160 may include a counting system 162 and an analyzer 172. The online tester 160 may correspond to the online tester 30 of FIG. 1. While not illustrated, entropy data may be directly provided to the online tester 160 from an entropy source. Furthermore, while not illustrated, an output of the online tester 160 may be provided to an encryption engine.

The counting system 162 may include logical gate 174, memory 164, counter 166, counter 168 and counter 170. The memory 164 may store bits of the entropy data and provide the bits to the logical gate 174, counter 166, and counter 168. While not illustrated, the counter 170 may be connected to the memory 164 to receive the entropy data.

A normal correlation equation may follow the formula:

$$c = \frac{n ( {\sum }_{i = 0}^{n - 1} {x}_{i} {y}_{i} ) - ( {\sum }_{i = 0}^{n - 1} {x}_{i} ) ( {\sum }_{i = 0}^{n - 1} {y}_{i} )}{\sqrt{( n {\sum }_{i = 0}^{n - 1} {x}_{i}^{2} - {( {\sum }_{i = 0}^{n - 1} {x}_{i} )}^{2} ) ( n {\sum }_{i = 0}^{n - 1} {y}_{i}^{2} - {( {\sum }_{i = 0}^{n - 1} {y}_{i} )}^{2} )}}$$

To determine SCC, it may be possible to replace yᵢ with x_{i+1 mod n}. The SCC may be represented as integers rather than floating point numbers. For example, SCC may be represented as the following equation, where xᵢ represents a current bit value (e.g., 1 or 0) and xᵢ₊₁ represents a next bit value (e.g., 1 or 0):

$$scc = \frac{n ( {\sum }_{i = 0}^{n - 1} {x}_{i} {x}_{( i + 1 mod n )} ) - {( {\sum }_{i = 0}^{n - 1} {x}_{i} )}^{2}}{n ( {\sum }_{i = 0}^{n - 1} {x}_{i}^{2} ) - {( {\sum }_{i = 0}^{n - 1} {x}_{i} )}^{2}}$$

It is understood that where xᵢ may also be referred to as a previous bit value and xᵢ₊₁ could be referred to as a current bit value. The SCC may be recast to arrive at other representations which utilize integers rather than floating point math, thereby allowing utilization of the counting system 162 and analyzer 172.

The SCC may be equivalent to:

scc=2P(xᵢ=xᵢ₊₁)−1

That is, the SCC may be equivalent to one being subtracted from two times the probability that the current bit value xᵢ being equivalent to the next bit value xᵢ₊₁. From the above equation it is possible to ascertain the following:

SCC>0:P(xᵢ=xᵢ₊₁)>0.5,

SCC=0:P(xᵢ=xᵢ₊₁)=0.5, and

SCC<0:P(xᵢ=xᵢ₊₁)<0.5

Therefore, SCC may vary from −1.0 to +1.0, while the P value may vary from 0 to 1.0. When the SCC is 0, there is no correlation and the data may be deemed random. When the SCC is −1, the next bit value xᵢ₊₁ is always the opposite of the current bit value xᵢ, and when the SCC is 1, the current bit value xᵢ and next bit value xᵢ₊₁ are always the same value. Thus, the SCC may vary with different levels of correlation between −1 to 1. The probability P may vary from 0 to 1, with the probability P representing the probability that the next bit value will be equal to the current bit value. Therefore, the SCC may be represented as integers rather than floating point numbers.

From scc=2P(xᵢ=xᵢ₊₁)−1, it may be possible to determine that the number of times of current bit value xᵢ being equal to next bit value xᵢ₊₁ may be counted and stored by the counting system 162. For example, memory 164 may store values for the next bit value xᵢ₊₁ and current bit value xᵢ. The values may be provided to the logical gate 174 which outputs a corresponding value to the counter 166 when the next bit value xᵢ₊₁ and current bit value xᵢ are equal. The counter 166 may increment a count of the counter 166 when the output of the logical gate 174 indicates that next bit value xᵢ₊₁ and current bit value xᵢ are equal in value. The next bit value xᵢ₊₁ and current bit value xᵢ are adjacent each other in the entropy data. For example if xᵢ corresponds to the 5^{th} bit, xᵢ₊₁ may correspond to the 6^{th} bit, and if xᵢ corresponds to the 1021 bit, xᵢ₊₁ may correspond to the 1022 bit, the count of counter 166 may be referred to as “countₓᵢ₌ₓᵢ₊₁.”

The number total number of bits having a high value (i.e., 1) in the entropy data may also be counted. For example, each time current bit value xᵢ is equal to 1, the counter 168 may increment its counter by one. Therefore, the count of counter 168 may be referred to as “count₁.” Count₁ may be utilized to determine the mean μ.

Counter 170 may count a total number of bits N of the entropy data which have been so far received by the online tester 160, regardless of a value of those bits. Thus, the count of the counter 170 may be referred to as “total number of bits N.” Once the total number of bits N reaches a predetermined value (e.g., 1024 or a power of 2), each of the counters 166, 168, 170 may provide the countₓᵢ₌ₓᵢ₊₁, the count₁ and the total number of bits N to the analyzer 172. For example, an overflow may detect when total number of bits N reaches the predetermined value, and prompt the analyzer 172 to begin analysis based upon the total number of bits N, the countₓᵢ₌ₓᵢ₊₁, and the count₁.

When the total number of bits reaches N the predefined value, as noted above the counters 166, 168 may provide count₁ and countₓᵢ₌ₓᵢ₊₁ to the analyzer 172. Further, when the total number of counted bits N reaches the predefined value, counters 166, 168, 170 may be reset to zero. Moreover, when the total number of counted bits N reaches the predefined value, the counter 170 may provide the total number of bits N to the analyzer 172 as well, and output a sample strobe to the analyzer.

The analyzer 172 may determine the SCC and mean μ based upon the following. P(xᵢ=xᵢ₊₁) may be represented as (countₓᵢ₌ₓᵢ₊₁/total number of bits N). Therefore the SCC may be calculated as 2(countₓᵢ₌ₓᵢ₊₁/total number of bits N)−1. The mean μ may be represented as count₁/total number of bits N. Bounds may applied to the mean μ and the SCC to determine whether the data is sufficiently randomized, and a health tag or unhealthy tag may be applied to transformed data, which is the entropy data transformed, based upon the determination. For example, the SCC may need to be within certain boundaries (e.g., −0.3 to 0.3), and the mean μ may need to be within specific range of the (total number of bits N)/2. The boundaries may relate to minimum entropy, as described below.

The predetermined value described above may be selected to be a power of 2, for example 1024. By doing so, binary shifts may be used to calculate 2(countₓᵢ₌ₓᵢ₊₁/total number of bits N) for example. Therefore, the 2(countₓᵢ₌ₓᵢ₊₁/total number of bits N) operation may simply be a binary shift. For example, the binary shift of countₓᵢ₌ₓᵢ₊₁ may be 9 bits when total number of N=1024. As noted above, the predetermined value may correspond to when each of the total number of bits N, countₓᵢ₌ₓᵢ₊₁ and count₁ are utilized by the analyzer 172. In detail, dividing countₓᵢ₌ₓᵢ₊₁ by 1024 is 10 bits (binary shift right by 10 bits), and the quotient is multiplied by 2 (binary shift left by one bit), which results in a total binary shift to the right by 9 bits. Likewise, calculating count₁/(total number of bits N) may also be a binary shift operation.

For example, it may be possible to determine Z in the following equation: 2^{Z}=total number of bits N. The following calculations may be utilized by the analyzer 172:

x=countₓᵢ₌ₓᵢ₊₁>>Z−1

y=count₁>>Z

SCC=x−1

mean μ=y.

As described above, x is countₓᵢ₌ₓᵢ₊1 binary shifted to the right by Z−1, and y is count₁ binary shifted to the right by Z.

The size of the counters 166, 168, 170 may be determined based upon the predetermined number. For example, the counters 166, 168 may be 11 bits when the predetermined number is 1024 bits, and the counter 170 may be 10 bits.

The above may also utilize fixed point fractional arithmetic. While not illustrated, the analyzer 172 may determine whether an encryption engine is to perform cryptography based upon transformed data which is the entropy data transformed, and whether to label the transformed data as “healthy” or “unhealthy.” For example, the analyzer 172 may analyze the data with respect boundaries for the SCC and mean μ.

The SCC relates directly to countₓᵢ₌ₓᵢ₊₁, count₁ and N, and the SCC may be considered monotonic with the countₓᵢ₌ₓᵢ₊₁. Therefore, the analyzer 172 may determine a numerical measurement of a serial correlation of the values of bits of the entropy data by setting boundary conditions for each of the countₓᵢ₌ₓᵢ₊₁, and count₁ based upon the N, the desired SCC and a desired entropy level threshold, and comparing the countₓᵢ₌ₓᵢ₊₁, and count₁ to the boundary conditions to determine which boundary conditions the various counts are within. For example, various boundary conditions corresponding to different SCCs may be stored in a data structure (e.g., an array), and the countₓᵢ₌ₓᵢ₊₁, and count₁ may be compared to the boundary conditions to determine the numerical serial correlation of the entropy data, and whether the entropy data is sufficiently random. In some embodiments, the analyzer 172 may set boundary conditions only for countₓᵢ₌ₓᵢ₊₁, and may further set the boundary conditions based upon a size of the total number of bits N. Countₓᵢ₌ₓᵢ₊₁ may then be analyzed with references to the boundary conditions for countₓᵢ₌ₓᵢ₊₁ to determine whether the entropy data is sufficiently random. The boundary conditions may correspond to the SCC of the entropy data, to therefore provide a measurement of a serial correlation of the entropy data. For example, the boundary conditions may be the numerical measurement of a serial correlation of bits of the entropy data, and a data structure may store a relationship between countₓᵢ₌ₓᵢ₊₁, count₁, and the boundary conditions which may be the measurements of the serial correlation. Based upon which boundary conditions the countₓᵢ₌ₓᵢ₊₁, count₁ are within, the entropy data be determined to be suitable or unsuitable for the basis of encryption operation.

In some embodiments, the analyzer 172 may store values in a data structure (e.g., an array such as a lookup table) for countₓᵢ₌ₓᵢ₊₁, count₁ and N which correspond to SCC values. For example, the SCC may not need to be calculated by the analyzer 172 based upon the above equations. Rather, the analyzer 172 may determine the randomness of the entropy data with reference to the values. An example data structure is provided in Table I below:

TABLE I

| total number of bits N | count₁ | countₓᵢ₌ₓᵢ₊₁ | SCC |
|---|---|---|---|
| K | A | D | H |
| L | B | E | I |
| M | C | F | J |

Each of the letters A-M correspond to numbers, some of which may the same. Therefore, the SCC may not be calculated according to the above equation, rather the data structure may be referenced to determine if the countₓᵢ₌ₓᵢ₊₁, count₁ and total number of bits N correspond to an acceptable SCC. Such a process may be implemented by the analyzer 172 to determine the SCC. In some embodiments, a user may simply review the countₓᵢ₌ₓᵢ₊₁, the count₁ and the total number of bits N to determine if they are acceptable, and based upon the relationship of the countₓᵢ₌ₓᵢ₊₁, the count₁ and the total number of bits N.

As noted above, SCC may be represented by:

$$scc = \frac{n ( {\sum }_{i = 0}^{n - 1} {x}_{i} {x}_{( i + 1 mod n )} ) - {( {\sum }_{i = 0}^{n - 1} {x}_{i} )}^{2}}{n ( {\sum }_{i = 0}^{n - 1} {x}_{i}^{2} ) - {( {\sum }_{i = 0}^{n - 1} {x}_{i} )}^{2}}$$

In some embodiments, one way to represent some of the above values of the SCC includes:

$${t}_{1} = ( {\sum }_{i = 0}^{n - 1} {x}_{i} {x}_{( i + 1 mod n )} ) , {t}_{2} = ( {\sum }_{i = 0}^{n - 1} {x}_{i}^{2} ) , {t}_{3} = ( {\sum }_{i = 0}^{n - 1} {x}_{i} ) .$$

In the above, t₂ accumulates values while t₃ adds up values. Therefore, the SCC may be represented as follows:

$$SCC = \frac{n \cdot {t}_{1} - {t}_{3}^{2}}{n \cdot {t}_{2} - {t}_{3}^{2}} .$$

It is possible to observe that t₁ only increments by 1 when both xᵢ=1 and xᵢ₊₁=1. That is, if either of current bit value xᵢ and next bit value xᵢ₊₁ has a value of 0, then t₁ does not increment by 1. Further, t₂ only increments when current bit value xᵢ is 1, and does not increment when current bit xᵢ value is 0. Moreover, t₃ may be identical in value to t₂, since t₃ only increments when current bit value xᵢ is 1, and not when current bit xᵢ is 0.

Furthermore, it may be possible to assign four patterns represented by count(xᵢ₊₁xᵢ). This may return four 8-bit integers, depending on a size of the analyzed entropy data, as count00, count01, count10, and count11. The 8-bit integer returns may depend on a total sample size n. For example, count00 may count when both xᵢ and xᵢ₊₁ are 0, count01 may count when xᵢ is 1 and xᵢ₊₁ is 0, and so on. The following may be assigned the values, t₁=count11, t₂=count01+count11, and t₃=t₂. Some counts, for example count00, may not be needed. The total number of bits N may be counted until a predetermined number is reached, which may be for example 256. The predetermined number may be set to match points in some random number generation architectures.

Therefore, two counters may be required, with one counter counting count01, with another counter counting count11. N may be preprogrammed to the analyzer 172, or counted by a counter. The following may be used to calculate the SCC

$$n = count 00 + count 01 + count 10 + count 11$$

$$scc = \frac{n ( count 11 ) - ( count 01 + count 11 ) ( count 01 + count 11 )}{n ( count 01 + count 11 ) - ( count 01 + count 11 ) ( count 01 + count 11 )}$$

Counter 166 may perform count11 for example, while counter 168 may perform count01. For example, the memory 164 and logical gate 174 may determine when the current bit value xᵢ and the next bit value xᵢ₊₁ both equal one, and the counter 166 may increment a counter when the determination indicates the current bit value xᵢ and the next bit value xᵢ₊₁ both equal one. Counter 168 may simply count each time current bit value xᵢ is equal to one. Counter 170 may count number of bits N since the last reset operation of the counters 166, 168, 170. When counter 170 reaches a predetermined number (e.g., 1024 or 256 for example), the number of bits N (which may be equivalent to “n” in the above equation), the number of bits N, count11 and the count01 may be utilized by the analyzer 172, which may calculate the SCC based upon the above equation.

Based upon the SCC formula above and count11 received from counter 166, count01 from counter 168, and the n value of counter 170, the analyzer 172 may determine SCC and mean μ of the entropy data. Based upon the randomness, the analyzer 172 may further determine whether to provide transformed data, which is the entropy data transformed, to an encryption engine, and whether to label the transformed data as “healthy” or “unhealthy.”

In some embodiments, it may be desirable to have a low SCC. Therefore, the divide may be avoided by determining if the denominator is much greater than the numerator. For example, in some embodiments it may be preferable to obtain a minimum entropy of at least 50%. To do so, the denominator would need to be around 2.4 times greater than the numerator. Four bits of precision would be sufficient to do so. This may include comparing upper bits of the numerator and the denominator. Since comparing the numerator and denominator may be sufficient, the above divide operation may be avoided.

In an embodiment, the SCC may be determined as follows. Since

$$( {\sum }_{i = 0}^{n - 1} {x}_{i} {x}_{( i + 1 mod n )} )$$

is only 1 when both current bit value xᵢ and next bit value xᵢ₊₁ are 1, we may only need to count the occurrences of current bit value xᵢ and next bit value xᵢ₊₁ both being equal to one, as count11. For example, the memory 164 and logical gate 174 may determine when the current bit value xᵢ and the next bit value xᵢ₊₁ both equal one, and the counter 166 may increment a counter when the determination indicates the current bit value xᵢ and the next bit value xᵢ₊₁ both equal one. The count of the counter 166 may be referred to as count11. That is, in the above equation,

$$( {\sum }_{i = 0}^{n - 1} {x}_{i} {x}_{( i + 1 mod n )} )$$

may be represented have the following output values as shown in Table II:

TABLE II

| xᵢ | x_{i+1 mod n} | Output Value |
|---|---|---|
| 0 | 0 | 0 |
| 0 | 1 | 0 |
| 1 | 0 | 0 |
| 1 | 1 | 1 |

Furthermore,

$$( {\sum }_{i = 0}^{n - 1} {x}_{i} ) and ( {\sum }_{i = 0}^{n - 1} {x}_{i}^{2} )$$

only increment when xᵢ is equal to one, and not when xᵢ is equal to zero. Thus, counter 168 may count the number of instances that xᵢ being equal to one, which may be referred to as count1.

$$( {\sum }_{i = 0}^{n - 1} {x}_{i} )$$

may only be incremented when xᵢ is equal to 1, therefore only the occurrences of 1 must be counted.

$$( {\sum }_{i = 0}^{n - 1} {x}_{i}^{2} )$$

may only be counted when xᵢ is equal to 1, and therefore similar to the above, only the occurrences of 1 must be counted.

Moreover, it may be possible to reduce the degree of freedom by 1 to eliminate the “mod n” from the above formula. Therefore, the following equation may be used:

$$scc = \frac{( n - 1 ) count 11 - count {1}^{2}}{( n - 1 ) count 1 - count {1}^{2}}$$

Counter 170 may count a total number of bits N of the entropy data, which may correspond to “n” in the above formula. When the total number reaches a predetermined value, count11, count1 and the total number of bits N are provided to the analyzer 172. Based upon the above formula, the analyzer 172 may calculate the SCC.

The predetermined value described above may be selected to be a power of 2, for example 1024. By doing so, binary shifts may be used to calculate the above. For example, it may be possible to determine Z in the following equation: 2^{Z}=total number of bits N. For example, the analyzer 172 may compute the following:

x←count1*count1,

y←count11<<Z, and

z←count1<<Z.

That is, count11 and count1 may each be left shifted Z times to obtain y and z respectively. Thus, the analyzer 172 may determine the following:

scc←(y−x)/(z−x), and

mean μ←count1>>Z.

Similar to the above embodiments, a health tag (e.g., healthy or unhealthy) may be applied to the transformed data, which is based upon the entropy data and mean μ, and passed to an encryption engine. Fixed point fractional arithmetic may be utilized.

Further improvements may be obtained, by for example setting the predetermined number to a power of 2 by choosing how much data to measure to thereby eliminate at least two multiples. Furthermore, the divide may be avoided when the SCC is desired to be low. Thus, rather than dividing, it may be sufficient to merely determine whether the denominator is sufficiently larger than the numerator. This may be accomplished by comparing upper bits of the numerator and denominator.

The above SCC equation is based upon integer arithmetic, and can be detected in a single clock cycle or multiple clock cycles.

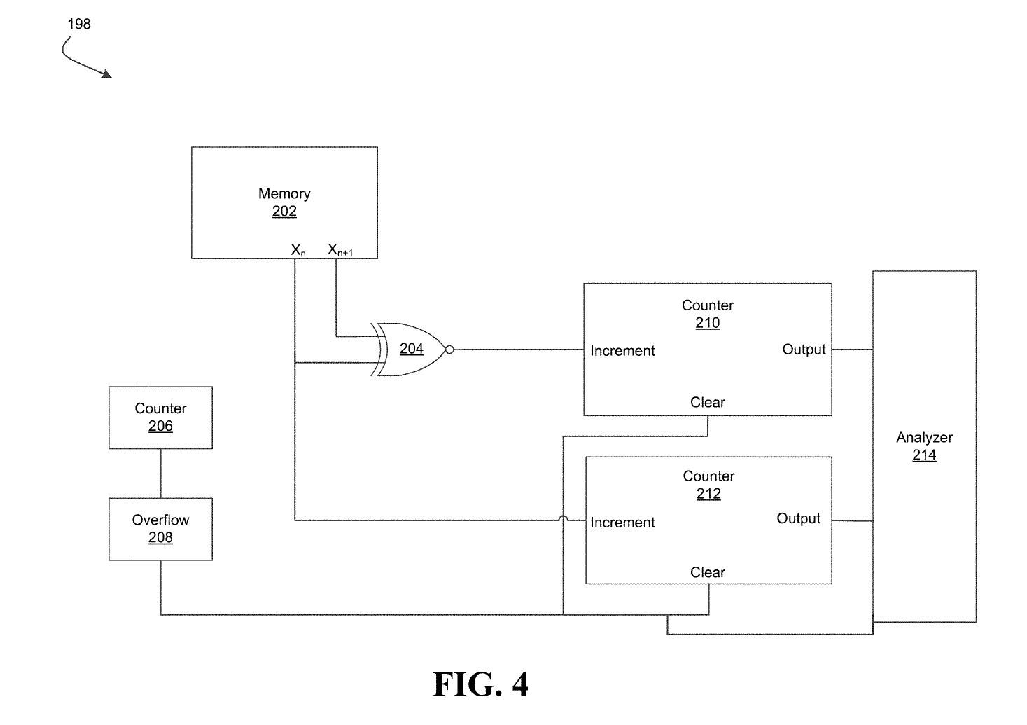

FIG. 4 illustrates an online health tester 198. The online health tester 198 may be connected to an entropy source (not shown) that produces entropy data. The online health tester 198 may include memory 202 and counter 206. At least one of the memory 202 or counter 206 may be directly connected to the entropy source to receive the entropy data directly from the entropy source. The memory 202 may include latches such as, for example, a D latch.

The memory 202 may output the next bit value Xₙ₊₁, and the current bit value Xₙ to an Exclusive NOR gate (XNOR) 204. The result of the XNOR gate may be high (e.g., 1) if current bit value Xₙ has a same value as the next bit value Xₙ₊₁ (e.g., both of current bit value Xₙ and next bit value Xₙ₊₁ is 0, or both of current bit value Xₙ and next bit value Xₙ₊₁ is 1), but has a low (e.g., 0) value if current bit value Xₙ is a different value from next bit value Xₙ₊₁. The result of the XNOR gate 204 may be provided to counter 210 as a high or low signal.

The counter 210 may increment a count of the counter 210 when the signal received from the XNOR gate 204 is high (i.e., when Xₙ₊₁=Xₙ). The count of the counter 210 may be referred to as countₓᵢ₌ₓᵢ₊₁. Countₓᵢ₌ₓᵢ₊₁ may be provided to the analyzer 214.

Counter 212 may receive the current bit value Xₙ. If the current bit Xₙ value is high, counter 212 may increment a count of the counter 212. The count of counter 212 may be referred to as count₁. If the current bit value Xₙ is low, then count₁ may not be incremented by counter 212. Count₁ may be provided to the analyzer 214.

Counter 206 may be a free counter, and may count a total number of bits N of the entropy data. That is, counter 206 may count the total number of bits N (e.g., 1024) of the entropy data which have been so far received by the online tester 198, regardless of a value of those bits. The count of the counter 206 may be referred to as a count N. The count N of the counter 206 may be provided to overflow 208.

The overflow 208 may determine when the count N reaches a predetermined value, for example when the most significant bit of the count N changes value from 1 to 0. The predetermined value may be a power of 2. When the count N reaches the predetermined value, the overflow 208 provides a signal (e.g., a strobe signal) to the counters 206, 210, 212 to reset the counters 206, 210, 212, and to the analyzer 214 to indicate that the predetermined number of bits has been reached and demarcate the boundary of the entropy data to be analyzed by the analyzer 214. Once the analyzer 214 receives the signal from the overflow 208, the analyzer may use count₁ and countₓᵢ₌ₓᵢ₊₁ to determine the SCC and mean μ. For example, it may be possible to determine Z in the following equation: 2^{Z}=total number of bits N. The following calculations may be utilized by the analyzer 214:

x=countₓᵢ₌ₓᵢ₊₁>>Z−1

y=count₁>>Z

SCC=x−1

mean μ=y.

The analyzer 214 may be connected to the counter 206 to receive the count N from the counter 206. In some embodiments, the analyzer 212 may be preprogrammed with the count N and may not receive count N from the counter 206. Rather, the analyzer 214 may receive the signal from the overflow 208, and utilize the preprogrammed count N in the formula.

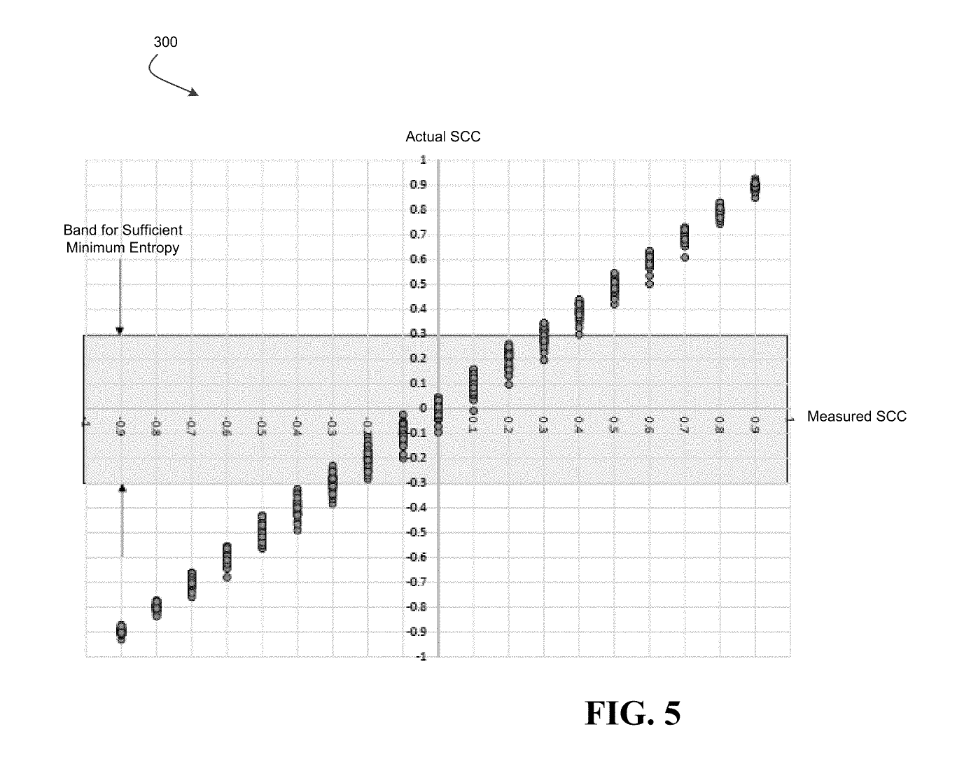

FIG. 5 is a graph 300 illustrating the measured SCC (X axis) versus the actual SCC (Y axis) of entropy data having 1024 bits. The measured entropy is based upon the formula scc=2P(xᵢ=xᵢ₊₁)−1, and is based upon entropy data of 1024 bits. The measured entropy may vary from the actual entropy by around 0.1. The measured SCC may be determined based upon the above apparatuses and methods. The band for sufficient minimum entropy may be based upon a correspondence between the minimum entropy and the actual SCC, as well as a correspondence between the measured SCC and the actual SCC. The measured SCC may be set so that the actual SCC cannot be outside of a range, which corresponds to the band for sufficient minimum entropy. As the number of bits of the entropy data increases, the measured SCC will conform more closely to the actual SCC.

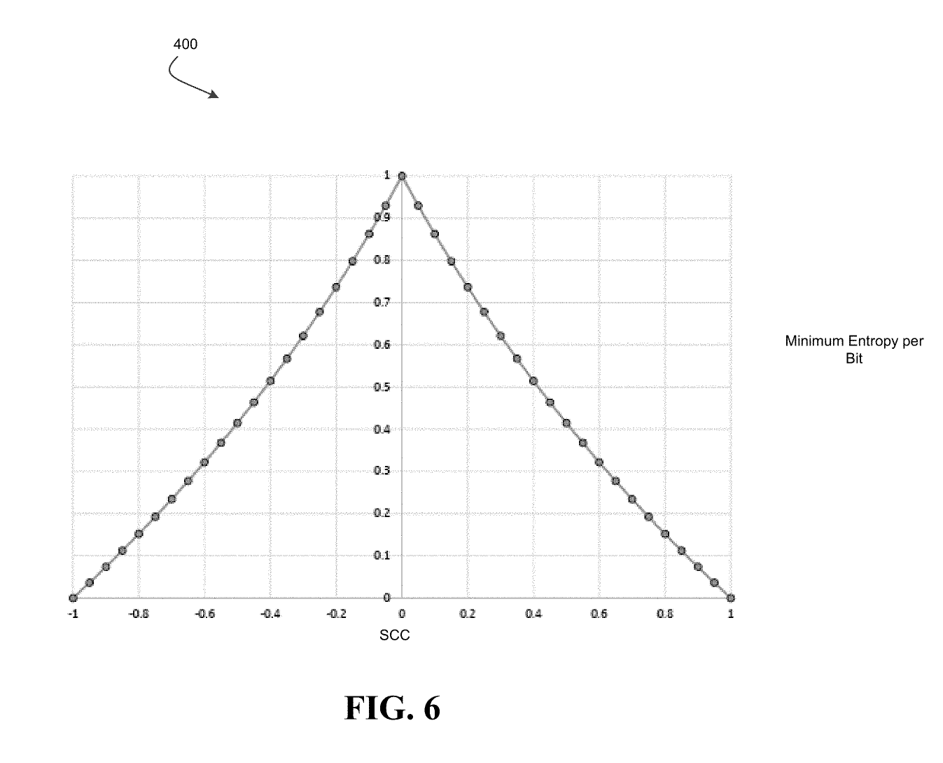

FIG. 6 illustrates a graph 400 of the SCC and the minimum entropy per bit. Minimum entropy is the most pessimistic way of measuring the amount of entropy in data, or the randomness of the data. The minimum entropy may be used to determine whether the entropy data may is sufficiently random. The minimum entropy may be calculated as follows:

$$for SCC < 0 , {H}_{∞} ( {\{ 0 , 1 \}}^{n} \vert scc = s ) = - {log}_{2} ( P ( {\{ 01 \}}^{\frac{n}{2}} ) ) , \\ for SCC > 0 , {H}_{∼} ( {\{ 0 , 1 \}}^{n} \vert scc = s ) = - {log}_{2} ( P ( {\{ 1 \}}^{n} ) ) .$$

This may correspond to the probability of a given binary string occurring given the entropy. With some manipulation, the minimum entropy may be derived to be:

$${H}_{∞} ( {\{ 0 , 1 \}}^{n} \vert scc = s ) = - {log}_{2} ( \frac{\vert s \vert}{2} + 0.5 )$$

The correlation of the SCC to the minimum entropy per bit may be above a certain range. For cryptographic reasons for example, the minimum entropy may need to above 50%, and therefore the absolute value of the SCC would need to be less than 0.414214. As another example, if the minimum entropy required is 70%, the absolute value of the SCC would need to be less than 0.231144. The entropy band of FIG. 5 may be set based upon the required minimum entropy, and the relationship of the measured SCC to minimum entropy and actual SCC. Lag-N may be determined instead of SCC in any of the embodiments herein. Furthermore, because the SCC may be monotonic with both the minimum entropy and the at least one of the counts described herein (e.g., countₓᵢ₌ₓᵢ₊₁), it may be possible to simply establish a data structure, such as an array, relating the minimum entropy to the SCC. Furthermore, boundaries for the counts may be established based upon the minimum entropy desired.

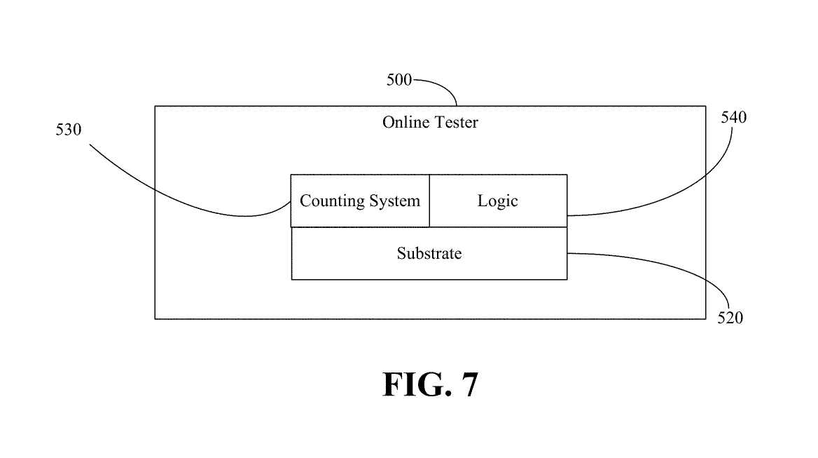

FIG. 7 illustrates an online test apparatus 500. The apparatus 500 may be implemented in one or more aspects of the method 80 (FIG. 2) and may be readily substituted for the online tester 30 (FIG. 1), and online tester 160 (FIG. 3), already discussed. The illustrated apparatus 500 includes a substrate 520 (e.g., silicon, sapphire, gallium arsenide) and logic 540 (e.g., transistor array and other integrated circuit/IC components) coupled to the substrate 520. The logic 540 may be implemented at least partly in configurable logic or fixed-functionality logic hardware. Moreover, the logic 540 may detect a statistical measurement of the entropy data, which may be the SCC.

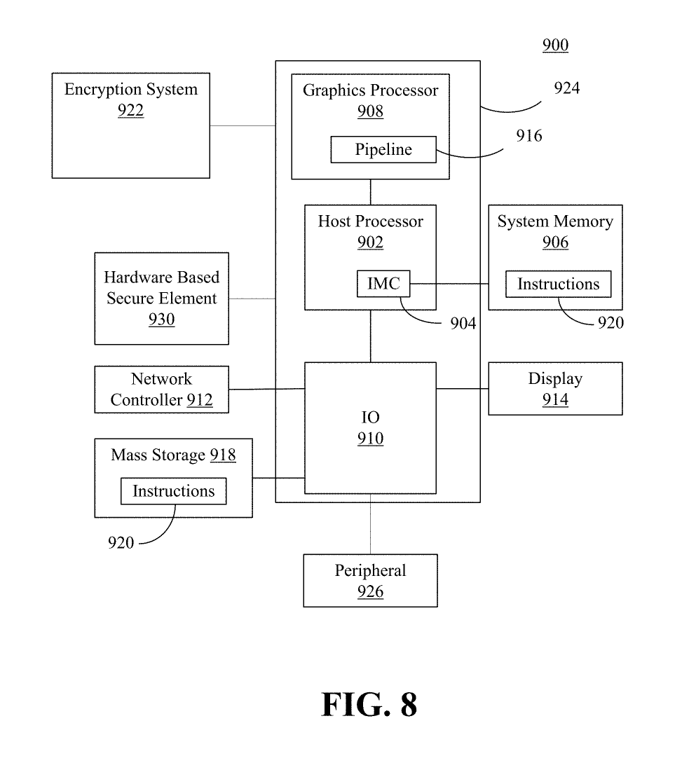

FIG. 8 illustrates a security-enhanced computing system 900. The illustrated system 900 includes a system on chip (SoC) 924 having a host processor (e.g., central processing unit/CPU) 902, a graphics processor 908 and an input/output (IO) module 910. In the illustrated example, the host processor 902 includes an integrated memory controller (IMC) 904 that communicates with a system memory 906 (e.g., DRAM).

The host processor 902 may be coupled to the graphics processor 908, which may include a graphics pipeline 916, and the IO module 910. The IO module 910 may be coupled to a network controller 912 (e.g., wireless and/or wired), a display 914 (e.g., fixed or head mounted liquid crystal display/LCD, light emitting diode/LED display, etc., to visually present a video of a 3D scene) and mass storage 918 (e.g., flash memory, optical disk, solid state drive/SSD).

The illustrated system 900 includes an encryption system 920, which may operate and include features as described herein, for example similarly to the encryption system 12 described in FIG. 1. The encryption system 922 may be connected to the SoC 924. Prior to transmitting sensitive information through the network controller 912, sensitive information may be encrypted by the encryption system 922. Therefore, the sensitive information may be encrypted prior to transmission over the internet for example. Furthermore, information may be encrypted prior to storage, in for example the mass storage 918 for added security. Moreover, communication between a hardware based secure element 930 and a peripheral 926 (e.g., keyboard, display, mouse, printer, etc.) may be encrypted. The hardware based secure element 930 may be coupled to the chip 924. Any device which provides data to be encrypted may be referred to as a “data provider,” and any data which is to be encrypted may be referred to as “system data” or “data.”

In some embodiments, the encryption system 922 may be part of the SoC 924. In some embodiments, the system memory 906 and/or the mass storage 918 may include instructions 920, which when executed by the host processor 902 and/or the graphics processor 908, cause the system 900 to perform one or more aspects of the method 80 (FIG. 2). Thus, the system 900 may be configured to determine and measure a statistical measurement of entropy data, and to determine, based upon the statistical measurement, if the entropy data is suitable for an encryption operation to be performed. Transformed data, which is based upon the entropy data, may be used by an encryption engine to perform the encryption when the entropy data is determined to be suitable. In some embodiments, parts of the encryption system 922 (e.g., the entropy source, counting system, transformer and encryption engine) are implemented by the SoC 924, while other parts of the encryption system 922 (e.g., analyzer) are implemented by the system memory 906.

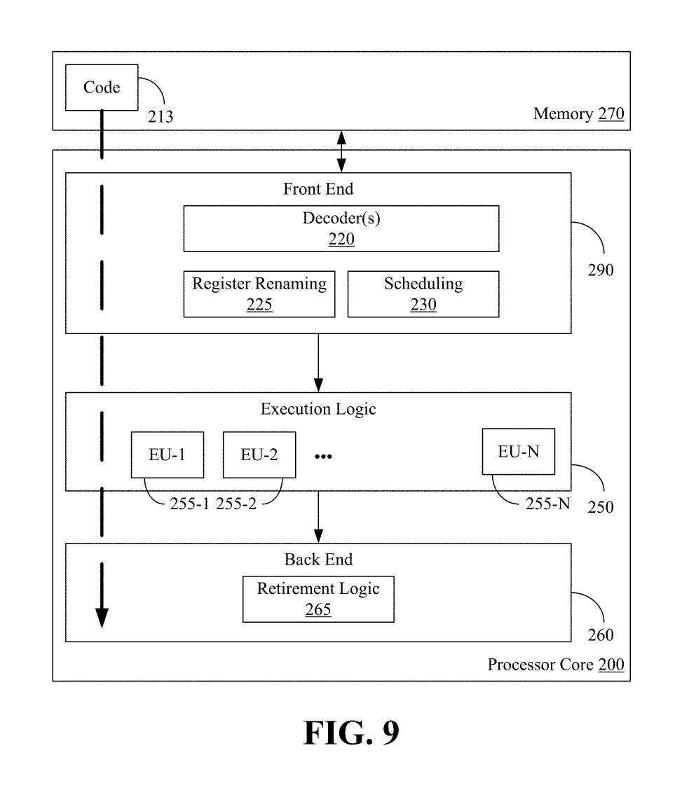

FIG. 9 illustrates a processor core 200 according to an embodiment. The processor core 200 may be the core for any type of processor, such as a micro-processor, an embedded processor, a digital signal processor (DSP), a network processor, or other device to execute code. Although only one processor core 200 is illustrated in FIG. 5, a processing element may alternatively include more than one of the processor core 200 illustrated in FIG. 9. The processor core 200 may be a single-threaded core or, for at least one embodiment, the processor core 200 may be multithreaded in that it may include more than one hardware thread context (or “logical processor”) per core.

FIG. 9 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the method 80 (FIG. 2), already discussed. For example, the code 213 may execute the logic of the online tester 30, illustrated in for example FIG. 1. The processor core 200 may further implement a counting system 32 and analyzer 34, illustrated in for example FIG. 1. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 9, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

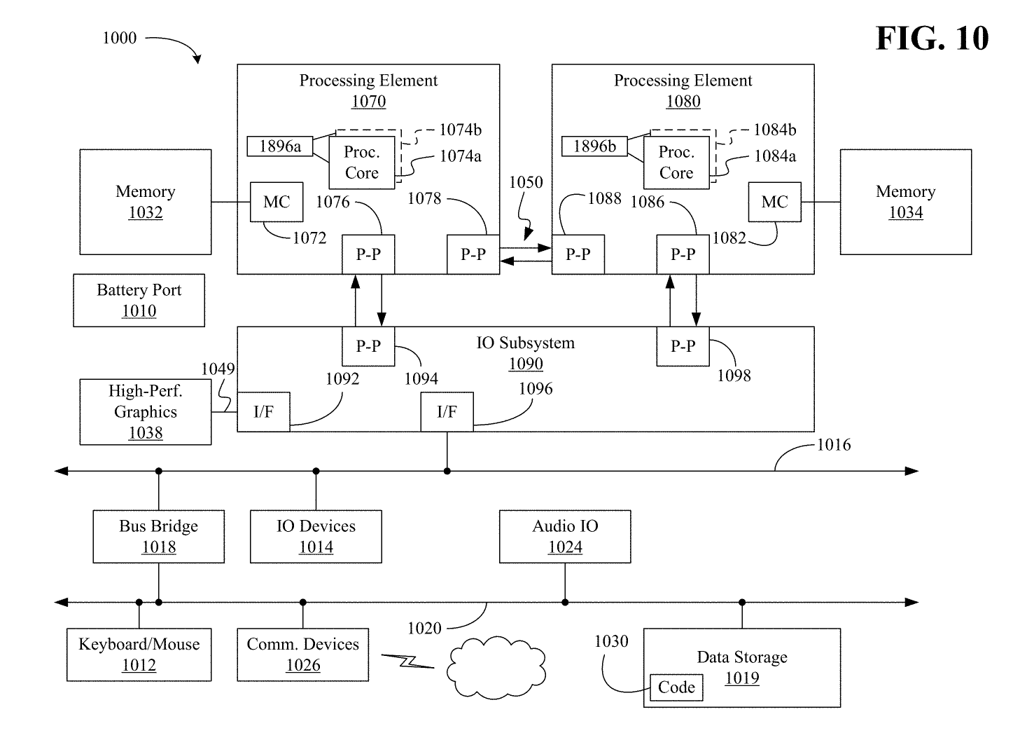

Referring now to FIG. 10, shown is a block diagram of a computing system 1000 embodiment in accordance with an embodiment. Shown in FIG. 10 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 10 may be implemented as a multi-drop bus rather than point-to-point interconnect.

As shown in FIG. 10, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 9.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 10, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 10, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 10 various I/O devices 1014 (e.g., speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030, which may be similar to the code 213 (FIG. 9), may implement one or more aspects of the method 30 (FIG. 2) and/or the encryption system 12 (FIG. 1), already discussed. The encryption system 12 may further be implemented by one or more of the processing elements 1070 and 1080. Further, an audio I/O 1024 may be coupled to second bus 1020 and a battery port 1010 may supply power to the computing system 1000.

### Additional Notes and Examples

Example 1 may include a security-enhanced computing system comprising a system memory to store system data, a chip coupled to the system memory, and an encryption subsystem coupled to the chip and including an entropy source to provide entropy data, and an online tester directly connected to the entropy source to receive the entropy data, the online tester to determine a measurement of a serial correlation of values of bits of the entropy data, and to determine, based upon the measurement of the serial correlation, if the entropy data is suitable as a basis for an encryption operation to be performed on the system data.

Example 2 may include the system of example 1, wherein the online tester includes a plurality of counters that are each to count the entropy data, and an analyzer to determine the measurement of the serial correlation based upon the counts of the counters.

Example 3 may include the system of example 2, wherein the measurement of the serial correlation is a serial correlation coefficient, and wherein if the serial correlation coefficient is within a predetermined range, the online tester is to determine that the entropy data is suitable.

Example 4 may include the system of example 2, wherein the analyzer is to determine the measurement of the serial correlation based upon a data structure storing a relationship between the counts and the measurement of the serial correlation.

Example 5 may include the system of any one of examples 2-4, wherein the counters include a first counter to count each time that directly adjacent bits of the entropy data store the same value, a second counter to count each time a predetermined value occurs in the entropy data, and a third counter to count a total number of bits of the entropy data.

Example 6 may include the system of example 1, further comprising a transformer to receive the entropy data and to transform the entropy data into transformed data, the transformed data being associated with a first label when the online tester determines that the entropy data is suitable, and a second label when the online tester determines that the entropy data is unsuitable, and an encryption engine to perform the encryption operation based upon the transformed data when the transformed data is associated with the first label.

Example 7 may include an online testing apparatus comprising a substrate, and logic coupled to the substrate and implemented at least partly in one or more of configurable logic or fixed-functionality logic hardware, the logic to receive entropy data from an entropy source, determine a measurement of a serial correlation of values of bits of the entropy data, and determine, based upon the measurement of the serial correlation, if the entropy data is suitable as a basis for an encryption operation to be performed on data.

Example 8 may include the apparatus of example 7, further comprising a plurality of counters that are each to count the entropy data, the plurality of counters being coupled to the substrate, and wherein the logic is to determine the measurement of the serial correlation based upon the counts of the counters.

Example 9 may include the apparatus of example 8, wherein the measurement of the serial correlation is a serial correlation coefficient, if the serial correlation coefficient is within a predetermined range, the logic is to determine that the entropy data is suitable.

Example 10 may include the apparatus of example 8, wherein the logic is to determine the measurement of the serial correlation based upon a data structure storing a relationship between the counts of the counters and the measurement of the serial correlation.

Example 11 may include the apparatus of any one of examples 8-10, wherein the counters include a first counter to count each time adjacent bits of the entropy data store the same value, a second counter to count each time a predetermined value occurs in the entropy data, and a third counter to count a total number of bits of the entropy data.

Example 12 may include the apparatus of example 7, wherein the entropy data is transformed by a transformer to determine transformed data, and the logic is to associate the transformed data with a first label when the logic determines that the entropy data is suitable, and associate a second label with the transformed data when the logic determines that the entropy data is unsuitable.

Example 13 may include a method of operating an online testing apparatus, comprising receiving entropy data from an entropy source, determining a measurement of a serial correlation of values of bits of the entropy data, and determining, based upon the measurement of the serial correlation, if the entropy data is suitable as a basis for an encryption operation to be performed on data.

Example 14 may include the method of example 13, further comprising counting different counts of the entropy data, and wherein the determining the measurement is based upon the counts.

Example 15 may include the method of example 14, wherein the measurement of the serial correlation is a serial correlation coefficient, and the determining if the entropy data is suitable includes if the serial correlation coefficient is within a predetermined range, determining that the entropy data is suitable.

Example 16 may include the method of example 14, wherein the determining the measurement of the serial correlation is based upon a data structure storing a relationship between the counts and the measurement of the serial correlation.

Example 17 may include the method of any one of examples 14-16, wherein the counting includes counting as a first count of the different counts, each time that directly adjacent bits of the entropy data store the same value, counting as a second count of the different counts, each time that a predetermined value occurs in the entropy data, and counting as a third count of the different counts, a total number of bits of the entropy data.

Example 18 may include the method of example 13, wherein the entropy data is transformed by a transformer to determine transformed data, and the method further comprising associating the transformed data with a first label when the entropy data is determined as suitable, and associating a second label with the transformed data when the entropy data is determined as unsuitable.

Example 19 may include at least one computer readable storage medium comprising a set of instructions, which when executed, cause a computing system to receive entropy data from an entropy source, determine a measurement of a serial correlation of values of bits of the entropy data, and determine, based upon the measurement of the serial correlation, if the entropy data is suitable for an encryption operation to be performed on data.

Example 20 may include the at least one computer readable storage medium of example 19, wherein the instructions, when executed, cause the computing system to count different counts of the entropy data, and wherein the determine the measurement is to be based upon the counts.

Example 21 may include the at least one computer readable storage medium of example 20, wherein the instructions, when executed, cause the computing system determine the measurement of the serial correlation to be a serial correlation coefficient, determine if the serial correlation coefficient is within a predetermined range, and determine that the entropy data is suitable if the serial correlation coefficient is within the predetermined range.

Example 22 may include the at least one computer readable storage medium of example 20, wherein the instructions, when executed, cause the computing system to determine the measurement of the serial correlation based upon a data structure storing a relationship between the counts and the measurement of the serial correlation.

Example 23 may include the at least one computer readable storage medium of any one of examples 20 to 22, wherein the instructions, when executed, cause the computing system to count as a first count of the different counts, each time that directly adjacent bits of the entropy data store the same value, count as a second count of the different counts, each time that a predetermined value occurs in the entropy data, and count as a third count of the different counts, a total number of bits of the entropy data.

Example 24 may include the at least one computer readable storage medium of example 19, wherein the instructions, when executed, cause the computing system to associate transformed data with a first label when the entropy data is determined as suitable, and associate the transformed data with a second label when the entropy data is determined as unsuitable, wherein the entropy data is to be transformed by a transformer to determine the transformed data.

Example 25 may include an online testing apparatus comprising means for receiving entropy data from an entropy source, means for determining a measurement of a serial correlation of bits of the entropy data, and means for determining, based upon the measurement of the serial correlation, if the entropy data is suitable as a basis for an encryption operation to be performed on data.

Example 26 may include the apparatus of example 25, further comprising means for counting different counts of the entropy data, and wherein the means for determining the measurement includes a means for determining the measurement based upon the counts.

Example 27 may include the apparatus of example 26, wherein the means for determining the measurement includes a means for determining the measurement as a serial correlation coefficient, and the means for determining if the entropy data is suitable includes means for determining that the entropy data is suitable if the serial correlation coefficient is within a predetermined range.

Example 28 may include the apparatus of example 26, wherein the means for determining the measurement of the serial correlation includes a means for determining the measurement based upon a data structure that is to store a relationship between the counts and the measurement of the serial correlation.

Example 29 may include the apparatus of any one of examples 26-28, wherein the means for counting includes means for counting as a first count of the different counts, each time that directly adjacent bits of the entropy data store the same value, means for counting as a second count of the different counts, each time that a predetermined value occurs in the entropy data, and means for counting as a third count of the different counts, a total number of bits of the entropy data.

Example 30 may include the apparatus of example 25, wherein the entropy data is transformed by a transformer means to determine transformed data, and the apparatus further comprising means for associating the transformed data with a first label when the entropy data is determined as suitable, and associating a second label with the transformed data when the entropy data is determined as unsuitable.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a system memory to store system data;
a chip coupled to the system memory; and
an encryption subsystem coupled to the chip and including:
an entropy source to provide entropy data; and
an online tester directly connected to the entropy source to receive the entropy data, the online tester to determine a measurement of a serial correlation of values of bits of the entropy data, and to determine, based upon the measurement of the serial correlation, if the entropy data is suitable as a basis for an encryption operation to be performed on the system data.

2. The system of claim 1, wherein the online tester includes:
a plurality of counters that are each to count the entropy data; and
an analyzer to determine the measurement of the serial correlation based upon the counts of the counters.

3. The system of claim 2, wherein the measurement of the serial correlation is a serial correlation coefficient, and wherein if the serial correlation coefficient is within a predetermined range, the online tester is to determine that the entropy data is suitable.

4. The system of claim 2, wherein the analyzer is to determine the measurement of the serial correlation based upon a data structure storing a relationship between the counts and the measurement of the serial correlation.

5. The system of claim 2, wherein the counters include:
a first counter to count each time that directly adjacent bits of the entropy data store the same value;
a second counter to count each time a predetermined value occurs in the entropy data; and
a third counter to count a total number of bits of the entropy data.

6. The system of claim 1, further comprising:
a transformer to receive the entropy data and to transform the entropy data into transformed data, the transformed data being associated with a first label when the online tester determines that the entropy data is suitable, and a second label when the online tester determines that the entropy data is unsuitable; and
an encryption engine to perform the encryption operation based upon the transformed data when the transformed data is associated with the first label.

7. An apparatus comprising:
a substrate; and
logic coupled to the substrate and implemented at least partly in one or more of configurable logic or fixed-functionality logic hardware, the logic to:
receive entropy data from an entropy source,
determine a measurement of a serial correlation of values of bits of the entropy data, and
determine, based upon the measurement of the serial correlation, if the entropy data is suitable as a basis for an encryption operation to be performed on data.

8. The apparatus of claim 7, further comprising:
a plurality of counters that are each to count the entropy data, the plurality of counters being coupled to the substrate, and
wherein the logic is to determine the measurement of the serial correlation based upon the counts of the counters.

9. The apparatus of claim 8, wherein the measurement of the serial correlation is a serial correlation coefficient,
if the serial correlation coefficient is within a predetermined range, the logic is to determine that the entropy data is suitable.

10. The apparatus of claim 8, wherein the logic is to determine the measurement of the serial correlation based upon a data structure storing a relationship between the counts of the counters and the measurement of the serial correlation.

11. The apparatus of claim 8, wherein the counters include:
a first counter to count each time adjacent bits of the entropy data store the same value;
a second counter to count each time a predetermined value occurs in the entropy data; and
a third counter to count a total number of bits of the entropy data.

12. The apparatus of claim 7, wherein:
the entropy data is transformed by a transformer to determine transformed data; and
the logic is to associate the transformed data with a first label when the logic determines that the entropy data is suitable, and associate a second label with the transformed data when the logic determines that the entropy data is unsuitable.

13. A method of operating an apparatus, comprising:
receiving entropy data from an entropy source;
determining a measurement of a serial correlation of values of bits of the entropy data; and
determining, based upon the measurement of the serial correlation, if the entropy data is suitable as a basis for an encryption operation to be performed on data.

14. The method of claim 13, further comprising:
counting different counts of the entropy data, and
wherein the determining the measurement is based upon the counts.

15. The method of claim 14, wherein:
the measurement of the serial correlation is a serial correlation coefficient; and
the determining if the entropy data is suitable includes if the serial correlation coefficient is within a predetermined range, determining that the entropy data is suitable.

16. The method of claim 14, wherein the determining the measurement of the serial correlation is based upon a data structure storing a relationship between the counts and the measurement of the serial correlation.

17. The method of claim 14, wherein the counting includes:
counting as a first count of the different counts, each time that directly adjacent bits of the entropy data store the same value;
counting as a second count of the different counts, each time that a predetermined value occurs in the entropy data; and
counting as a third count of the different counts, a total number of bits of the entropy data.

18. The method of claim 13, wherein the entropy data is transformed by a transformer to determine transformed data; and
the method further comprising associating the transformed data with a first label when the entropy data is determined as suitable, and associating a second label with the transformed data when the entropy data is determined as unsuitable.

19. At least one computer readable storage medium comprising a set of instructions, which when executed, cause a computing system to:
receive entropy data from an entropy source;
determine a measurement of a serial correlation of values of bits of the entropy data; and
determine, based upon the measurement of the serial correlation, if the entropy data is suitable for an encryption operation to be performed on data.

20. The at least one computer readable storage medium of claim 19, wherein the instructions, when executed, cause the computing system to count different counts of the entropy data, and
wherein the determine the measurement is to be based upon the counts.

21. The at least one computer readable storage medium of claim 20, wherein the instructions, when executed, cause the computing system:
determine the measurement of the serial correlation to be a serial correlation coefficient;
determine if the serial correlation coefficient is within a predetermined range; and
determine that the entropy data is suitable if the serial correlation coefficient is within the predetermined range.

22. The at least one computer readable storage medium of claim 20, wherein the instructions, when executed, cause the computing system to:
determine the measurement of the serial correlation based upon a data structure storing a relationship between the counts and the measurement of the serial correlation.

23. The at least one computer readable storage medium of claim 20, wherein the instructions, when executed, cause the computing system to:
count as a first count of the different counts, each time that directly adjacent bits of the entropy data store the same value;
count as a second count of the different counts, each time that a predetermined value occurs in the entropy data; and
count as a third count of the different counts, a total number of bits of the entropy data.

24. The at least one computer readable storage medium of claim 19, wherein the instructions, when executed, cause the computing system to:
associate transformed data with a first label when the entropy data is determined as suitable; and
associate the transformed data with a second label when the entropy data is determined as unsuitable,
wherein the entropy data is to be transformed by a transformer to determine the transformed data.
